(19) United States
(12) Patent Application Publication
(10) Pub. No.: US 2019/0392803 A1
(43) Pub. Date: Dec. 26, 2019

(54) TRANSPOSING DEVICE, TRANSPOSING METHOD AND NON-TRANSITORY COMPUTER-READABLE STORAGE MEDIUM

(71) Applicant: YAMAHA CORPORATION, Hamamatsu-shi (JP)

(72) Inventor: Shuichi MATSUMOTO, Hamamatsu-shi (JP)

(21) Appl. No.: 16/558,743

(22) Filed: Sep. 3, 2019

Related U.S. Application Data
(63) Continuation of application No. PCT/JP2018/011130, filed on Mar. 20, 2018.

(30) Foreign Application Priority Data
Mar. 22, 2017 (JP) 2017-055779

(51) Int. Cl. G10H 1/36; G10H 1/00

(52) U.S. Cl. CPC G10H 1/361; G10H 1/0008; G10H 2220/091; G10H 2210/066; G10H 2210/081; G10H 2210/005

(57) ABSTRACT

In transposing a piece of music in accordance with the sound range of a musical instrument or the vocal range of a singer, an amount of transposition is determined in consideration of the sound range and a key signature resulting from the transposition. A transposing device according to an embodiment of the present invention includes a data acquisition unit configured to acquire a predetermined sound range, key information of a predetermined piece of music, and pitch information of sounds constituting the predetermined piece of music and a transposition amount determination unit configured to calculate a value of transposition evaluation on the basis of the sound range, the key information of the piece of music, and the pitch information and to determine an amount of transposition on the basis of the value of transposition evaluation.

### CROSS-REFERENCE TO RELATED APPLICATIONS

This application is a U.S. continuation application filed under 35 U.S.C. § 111(a), of International Application No. PCT/JP2018/011130, filed on Mar. 20, 2018, which claims priority to Japanese Patent Application No. 2017-055779, filed on Mar. 22, 2017, the disclosures of which are incorporated by reference.

### FIELD

The present invention relates to a technology for transposing a sound.

### BACKGROUND

There has been a device that automatically sets a playing key in accordance with the vocal range of a singer. For example, Japanese Patent Application Laid-Open No. 2004-046250 discloses a karaoke apparatus that measures the vocal range of a singer and automatically sets a playing key so that the middle of the vocal range of the singer and the middle of the sound range of the melody of a piece of music come close to each other.

### SUMMARY

According to an embodiment of the present invention, a transposing device including a data acquisition unit configured to acquire a predetermined sound range, key information of a predetermined piece of music, and pitch information of sounds constituting the predetermined piece of music and a transposition amount determination unit configured to calculate a transposition evaluation value on the basis of the sound range, the key information of the piece of music, and the pitch information and to determine an amount of transposition on the basis of the transposition evaluation value is provided.

According to an embodiment of the present invention, a transposing method including acquiring a predetermined sound range, key information of a predetermined piece of music, and pitch information of sounds constituting the predetermined piece of music, calculating a transposition evaluation value on the basis of the sound range, the key information of the piece of music, and the pitch information, and determining an amount of transposition on the basis of the transposition evaluation value is provided.

According to an embodiment of the present invention, non-transitory computer readable medium recording a program for causing a computer to execute operations including acquiring a predetermined sound range, key information of a predetermined piece of music, and pitch information of sounds constituting the predetermined piece of music, calculating a transposition evaluation value on the basis of the sound range, the key information of the piece of music, and the pitch information, and determining an amount of transposition on the basis of the of transposition evaluation value.

### BRIEF DESCRIPTION OF DRAWINGS

FIG. 1 is a block diagram showing a configuration of a transposing device according to an embodiment of the present invention;

FIG. 2 is a block diagram showing a configuration of a transposing function according to an embodiment of the present invention;

FIG. 3 is a diagram for explaining the sound range of each musical instrument;

FIG. 4 is a flow chart showing the flow of a method for transposing a piece of music;

FIG. 5 is a flow chart for explaining in more detail a concept of a calculation of a first evaluation value and a concept of a calculation of a second evaluation value;

FIG. 6 is a flow chart for explaining in more detail the concept of the calculation of the first evaluation value and the concept of the calculation of the second evaluation value; and

FIG. 7 is a diagram explaining an example of transposition according to the kind of a musical instrument.

### DESCRIPTION OF EMBODIMENTS

However, in the case of a musical instrument, it may be difficult to play the musical instrument, depending on the key of a piece of music. Accordingly, in the case of changing the playing key of a piece of music, it is necessary to change the playing key in consideration of the key signature of the piece of music thus changed depending on the kind of a musical instrument. However, the technology of Japanese Patent Application Laid-Open No. 2004-046250 fails to consider a key signature resulting from a change in playing key. Moreover, the technology of Japanese Patent Application Laid-Open No. 2004-046250 fails to consider the difficulty level of playing of a musical instrument according to the kind of the musical instrument.

According to an embodiment of the present invention makes it possible to determine an amount of transposition in consideration of the sound range and a key signature resulting from the transposition in transposing a piece of music in accordance with the sound range of a musical instrument or the vocal range of a singer. Another embodiment of the present invention makes it possible to determine an amount of transposition in consideration of the key-dependent difficulty level of playing of a musical instrument according to the kind of the musical instrument.

A transposing device according to an embodiment of the present invention is described in detail below with reference to the drawings. The following embodiments are examples of embodiments of the present invention, and the present invention is not limited to these embodiments.

### First Embodiment

A transposing device according to an embodiment of the present invention is described in detail below with reference to the drawings. A transposing device according to an embodiment of the present invention is a device including a function of transposing a piece of music according to the vocal range of a singer or the sound range of a musical instrument that is played by a player. This transposing device determines the necessity or nonnecessity of transposition of the piece of music on the basis of the vocal range of a singer or the sound range of a musical instrument that is played by a player and the pitch of a piece of music to be sung or played. In the case of transposing the piece of music as a result of the determination, the transposing device calculates, on the basis of the vocal range of the singer or the sound range of the musical instrument to be played by the player and the pitch of the piece of music, a first evaluation representing the difficulty level of singing or playing from the viewpoint of sound range. Furthermore, in the case of a piece of music involving the use of a musical instrument, the transposing device calculates, on the basis of the key of the piece of music and a key corresponding to the musical instrument, a second evaluation value representing the difficulty level of playing from the viewpoint of key. The transposing device determines an amount of transposition of the piece of music on the basis of the first evaluation value and the second evaluation value.

### [Hardware]

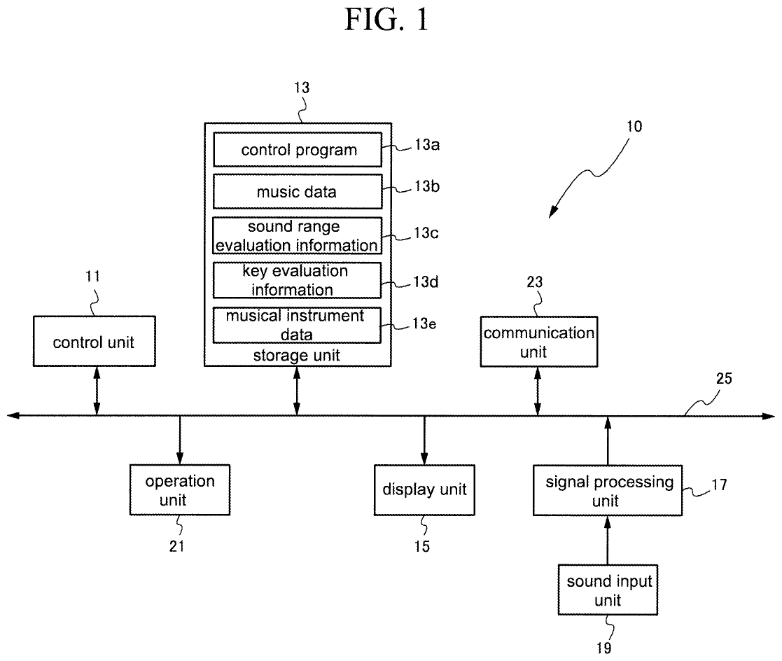

FIG. 1 is a block diagram showing a configuration of a transposing device 10 according to an embodiment of the present invention. The transposing device 10 includes a control unit 11, a storage unit 13, a display unit 15, and a signal processing unit 17. The signal processing unit 17 is connected to a sound input unit (such as a microphone) 19. Further, the transposing device 10 may optionally include an operation unit 21 and a communication unit 23. These components are mutually connected via a bus 25.

The control unit 11 includes an arithmetic processing circuit such as a CPU. The control unit 11 achieves various types of function through the transposing device 10 by using the CPU to execute a control program 13a stored in the storage unit 13. The functions to be achieved include a transposing function of transposing a piece of music that is offered to a singer or a player.

The storage unit 13 is a storage device such as a nonvolatile memory or a hard disk. The storage unit 13 has stored therein the control program 13a for achieving the transposing function. The control program 13a may be provided in a state of being stored in a computer-readable recording medium such as a magnetic recording medium, an optical recording medium, a magneto-optical recording medium, or a semiconductor memory. In this case, the transposing device 10 needs only include a device that reads the recording medium. Alternatively, the control program 13a may be downloaded over a network such as the Internet.

Further, the storage unit 13 stores music data 13b. The music data 13b is data associated with a piece of music and contains, for example, pitch information of sounds that constitute the piece of music, accompaniment information, lyric information, and the like. The accompaniment information is data representing an accompaniment to the piece of music. The pitch information and the accompaniment information may be data expressed in MIDI format such as SMF. Further, the music data 13b may also contain key information of the piece of music. Further, the music data 13b may also contain lyric data. The lyric data includes data for displaying the lyrics of a song and data indicating a timing at which to change the color of subtitles to the lyrics displayed. The music data 13b may be downloaded over a network such as the Internet.

Further, the storage unit 13 stores sound range evaluation information 13c and key evaluation information 13d. The sound range evaluation information 13c contains a sound range corresponding to a musical instrument or vocal range and an evaluation value associated with the sound range or the vocal range. When the sound range evaluation information 13c contains a vocal range and an evaluation value associated with the vocal range, the vocal range may be divided into a sound range corresponding to male voices and a sound range corresponding to female voices. In this case, the sound range evaluation information 13c may contain an evaluation value associated with the sound range corresponding to male voices and an evaluation value associated with the sound range corresponding to female voices. Alternatively, the vocal range may be further finely divided into classes of voice such as bass, tenor, alto, and soprano. The value of evaluation associated with the sound range or the vocal range represents the difficulty level of singing or playing according to the musical instrument from the viewpoint of sound range. The sound range evaluation information 13c may contain data expressed in MIDI format. The key evaluation information 13d corresponds to a musical instrument and contains a key and an evaluation value associated with the key. The evaluation value associated with the key represents the difficulty level of playing according to the musical instrument from the viewpoint of key. When the transposing device 10 deals with a piece of music related to singing, the key evaluation information 13d may be omitted. The sound range evaluation information 13c and the key evaluation information 13d may be downloaded over a network such as the Internet.

Further, the storage unit 13 may store musical instrument data 13e. The musical instrument data 13e represents reference sound data representing the sounds of various musical instruments. In a case where the after-mentioned operation unit 21 is used to designate what kind of musical instrument is used by a user of the transposing device 10, the musical instrument data 13e may be omitted. Although not illustrated, the storage unit 13 may store vocal range data representing reference sound data representing typical vocal ranges for each separate class of voice.

The display unit 15 is a display device, such as a liquid crystal display or an organic EL display, by which a screen based on control by the control unit 11 is displayed to a singer or a player on the basis of the control by the control unit 11.

The signal processing unit 17 includes an A/D converter and the like. A singing voice of a singer or an input sound of a musical instrument played by a player is converted by the sound input unit 19 into an electrical signal that is inputted to the signal processing unit 17, A/D converted by the signal processing unit 17, and outputted to the control unit 11.

The operation unit 21 is an operation button provided on an operation panel, a remote controller, and the like, or a device such as a keyboard, and a mouse, and the like, and outputs a signal corresponding to an input operation to the control unit 11. The user of the transposing device 10 may use the operation unit 21 to designate what kind of musical instrument he/she uses. The communication unit 23 connects to a communication line such as the Internet or a LAN on the basis of control of the control unit 11 and transmits and receives information to and from an external device such as a server. The function of the storage unit 13 may be achieved by an external device with which the communication unit 23 can communicate.

### [Transposing Function]

The transposing function which is achieved by the control unit 11 of the transposing device 10 executing the control program 13a stored in the storage unit 13 is described. Some or all of the components that achieve the transposing function to be described below may be achieved by hardware. Although the following description takes, as an example, a case where a piece of music to be performed on a musical instrument is a target of transposition, a transposing function according to an embodiment of the present invention may target a song.

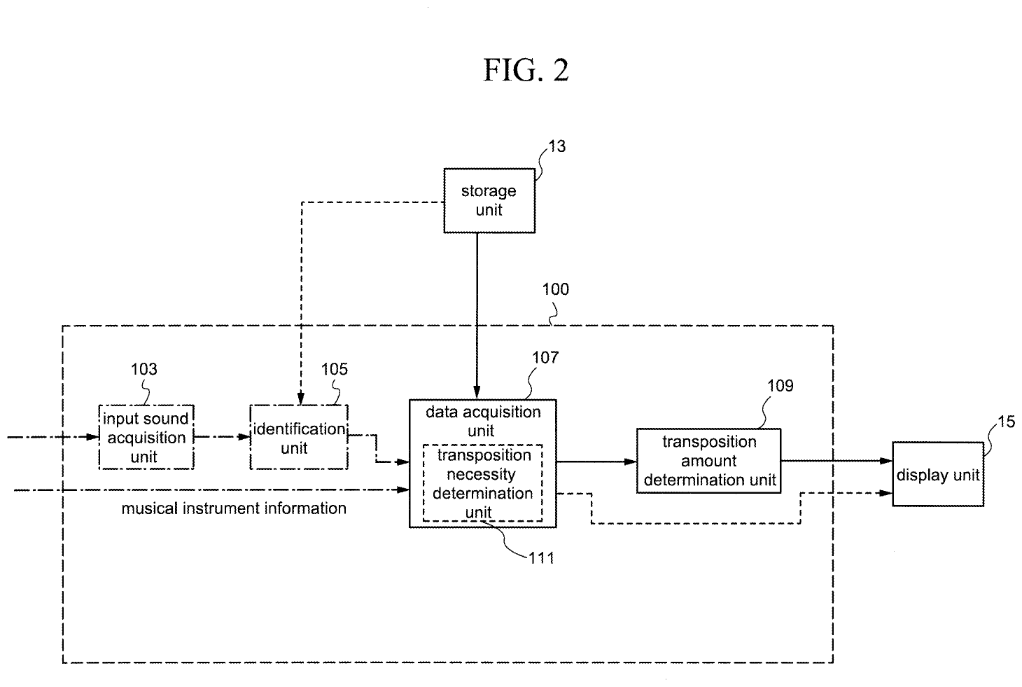

FIG. 2 is a block diagram showing a configuration of a transposing function 100 according to an embodiment of the present invention. As shown in FIG. 2, the transposing function 100 includes a data acquisition unit 107 and a transposition amount determination unit 109. As shown in FIG. 2, the transposing function 100 may include an input sound acquisition unit 103 and an identification unit 105.

When the kind of a musical instrument is identified on the basis of an input sound of the musical instrument in the transposing function 100, the input sound acquisition unit 103 acquires the input sound. The identification unit 105 acquires the input sound from the input sound acquisition unit 103. Further, the identification unit 105 acquires the musical instrument data 13e from the storage unit 13. The identification unit 105 compares the musical instrument data 13e with the input sound and identifies what musical instrument corresponds to the input sound. The identification unit 105 outputs information indicating the musical instrument thus identified to the data acquisition unit 107. Although identification of a musical instrument is described here, the identification unit 105 may identify the class of voice of a singer. In this case, the input sound acquisition unit 103 acquires a singing voice of the singer. The identification unit 105 may acquire vocal range data from the storage unit 13, compare the vocal range data with the singing voice, and identify what class of voice corresponds to the singing voice. It should be noted that the user may also use the operation unit 21 to designate the kind of a musical instrument or a class of voice. When the user selects the kind of a musical instrument or a class of voice, the input sound acquisition unit 103 and the identification unit 105, which are shown in FIG. 2, may be omitted. Further, in a case where the transposing function 100 target a particular musical instrument, the input sound acquisition unit 103 and the identification unit 105, which are shown in FIG. 2, may be omitted, as sound range evaluation information 13c and key evaluation information 13d both corresponding to the particular musical instrument have already been configured. The same applies to a case where the transposing function 100 target a particular class of voice.

The data acquisition unit 107 acquires musical instrument information indicating the kind of the musical instrument designated through the operation unit 21 or information indicating the musical instrument identified by the identification unit 105. The data acquisition unit 107 acquires sound range evaluation information 13c and key evaluation information 13d both corresponding to the musical instrument to be used from the storage unit 13 on the basis of the musical instrument information or the information indicating the musical instrument identified by the identification unit 105. The following describes the sound range evaluation information 13c and the key evaluation information 13d.

As mentioned above, the sound range evaluation information 13c contains a sound range corresponding to a musical instrument or vocal range and an evaluation value associated with the sound range or the vocal range. Note here that the sound range corresponding to the musical instrument or vocal range is associated with the pitch of a sound emitted from the musical instrument or the vocal range of a singer. The sound range contained in the sound range evaluation information 13c is divided into three or more ranges. The division into the ranges varies according to the musical instrument or the vocal range of the singer. In the case of playing of a musical instrument, the middle register is usually a sound range of musical notes that can be easily played. Meanwhile, the low register and the high register are more difficult to control than the middle register and are higher in difficulty level of playing than the middle register. The case of singing is substantially the same as the case of playing of a musical instrument. As a division of a sound range, for example, the sound range is set to a playable sound range and a non-playable sound range (hereinafter referred to as “unreachable sound range”) for each musical instrument. Furthermore, the playable sound range is divided into a sound range of musical notes that can be easily played (hereinafter referred to as “standard sound range”) and a sound range of musical notes that a trained player can play (hereinafter referred to as “rated sound range”). Further, the playable sound range may be divided into three ranges, namely the standard sound range and the rated sound range plus a sound range of musical notes that only a proficient player can play (hereinafter referred to as “special sound range”). The present embodiment illustrates an example in which the sound range contained in the sound range evaluation information 13c is divided into at least any three of the unreachable sound range, the rated sound range, the standard sound range, and the special sound range for each musical instrument. In the case of the vocal range of a singer, for example, the sound range may be set to a singable sound range and a non-singable sound range for each singer's class of voice, and furthermore, the singable sound range may be divided into a sound range of musical notes that can be easily sung and a sound range of musical notes that a trained singer can sing. Further, the singable sound range may be divided into three ranges, namely the standard sound range and the rated sound range plus a sound range of musical notes that only some proficient singers can sing.

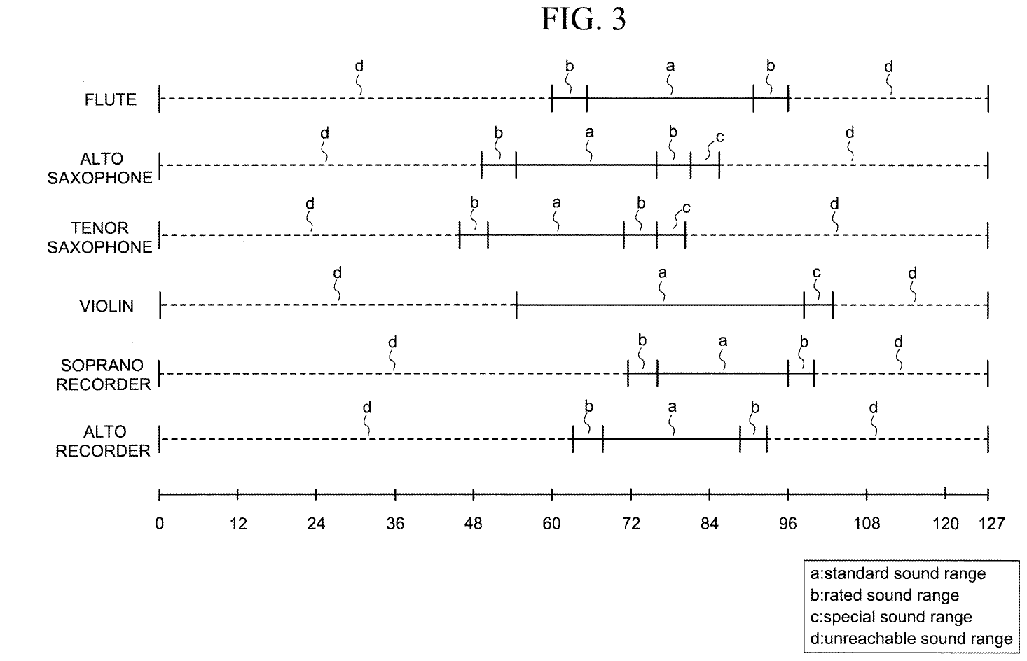

FIG. 3 is a diagram for explaining the sound range of each musical instrument. FIG. 3 shows the sound ranges of a flute, an alto saxophone, a tenor saxophone, a violin, a soprano recorder, and an alto recorder as examples. In FIG. 3, the horizontal axis represents MIDI note numbers, a's denote standard sound ranges, b's denote rated sound ranges, c's denote special sound ranges, and d's denotes unreachable sound ranges. The respective sound ranges of those musical instruments shown in FIG. 3 are shown in Table 1 below.

TABLE 1

| | Unreachable | Rated sound | Standard | Rated sound | Special sound | Unreachable |
|---|---|---|---|---|---|---|
| Musical | sound range | range | sound range | range | range | sound range |
| instrument | (pitch names) | (pitch names) | (pitch names) | (pitch names) | (pitch names) | (pitch names) |
| Flute | 0~59 | 60~63 | 64~92 | 93~96 | — | 97~127 |
| | (C-2~B2) | (C3~Eb3) | (E3~Ab5) | (A5~C6) | | (C#6~G8) |
| Alto | 0~50 | 51~54 | 55~75 | 76~81 | 82~85 | 86~127 |
| saxophone | (C-2~D2) | (Eb2~F#2) | (G2~Eb4) | (E4~A4) | (Bb4~C#5) | (D5~G8) |
| Tenor | 0~45 | 46~49 | 50~70 | 71~76 | 77~80 | 81~127 |
| saxophone | (C-2~A1) | (Bb1~C#2) | (D2~Bb3) | (B3~E4) | (F4~Ab4) | (A4~G8) |
| Violin | 0~54 | — | 55~99 | — | 100~102 | 103~127 |
| | (C-2~F#2) | | (G2~Eb6) | | (E6~F#6) | (G6~G8) |
| Soprano | 0~71 | 72~75 | 76~96 | 97~98 | — | 99~127 |
| recorder | (C-2~B3) | (C4~Eb4) | (E4~C6) | (C#6~D6) | | (Eb6~G8) |
| Alto recorder | 0~64 | 65~68 | 69~89 | 90~91 | — | 92~127 |
| | (C-2~E3) | (F3~Ab3) | (A3~F5) | (F#5~G5) | | (Ab5~G8) |

As shown in Table 1, the lowest note in the sound range of a flute is C3 of note number 60, and the highest note in the sound range is C6 of note number 96. Further, the lowest note in the sound range of an alto saxophone is Eb2 of note number 51, and the typical highest note in the sound range is A4 of note number 81. Further, the lowest note in the sound range of a tenor saxophone is Bb1 of note number 46, and the typical highest note in the sound range is E4 of note number 76. Further, the lowest note in the sound range of a violin is G2 of note number 55, and the typical highest note in the sound range is Eb6 of note number 99. Further, the lowest note in the sound range of a soprano recorder is C4 of note number 72, and the highest note in the sound range is D6 of note number 98. Further, the lowest note in the sound range of an alto recorder is F3 of note number 65, and the highest note in the sound range is G5 of note number 91.

It should be noted that the division of the sound range of each musical instrument is arbitrary. The division of the sound range of each musical instrument described with reference to FIG. 3 is merely an example, and the division of the sound range of each musical instrument is not limited to the division of the sound range described with reference to FIG. 3.

The sound range evaluation information 13c contains evaluation values associated with the sound range of each musical instrument as shown in Table 1. As mentioned above, the sound range of each musical instrument is divided into at least any three or more of the unreachable sound range, the rated sound range, the standard sound range, and the special sound range. In the sound range evaluation information 13c, different evaluation values are associated with the unreachable sound range, the rated sound range, the standard sound range, and the special sound range, respectively. Evaluation values associated with the sound ranges of each musical instrument are hereinafter referred to as “sound range difficulty level numbers”. Examples of sound range difficulty level numbers are shown in Table 2 below.

TABLE 2

| Sound range | Sound range difficulty level number |
|---|---|
| Standard sound range | 0 |
| Rated sound range | 10 |
| Special sound range | 100 |
| Unreachable sound range | 1000 |

As shown in Table 2, for example, the settings are configured such that the sound range difficulty level number of the standard sound range is 0, that the sound range difficulty level number of the rated sound range is 10, that the sound range difficulty level number of the special sound range is 100, and that the sound range difficulty level number of the unreachable sound range is 1000, and a larger sound range difficulty level number shows that it is more difficult to play the musical instrument. It should be noted that the setting of sound range difficulty level numbers for each sound range is arbitrary, and is not limited to the numerical values shown in Table 2, provided sound range difficulty level number of standard sound range<sound range difficulty level number of rated sound range<sound range difficulty level number of special sound range<sound range difficulty level number of unreachable sound range. The playable sound range and the division of the playable sound range vary according to the kind of the musical instrument. Therefore, the sound range evaluation information 13c is set for each musical instrument. Sound range evaluation information 13c containing sound ranges and sound range difficulty level numbers associated with the sound ranges may be stored in the storage unit 13 for each musical instrument as a data table such as that shown in Table 2. Similarly, in the case of sound range evaluation information 13c containing a vocal range and evaluation values associated with the vocal range, the sound range evaluation information 13c may contain, for each class of voice, vocal ranges and sound range difficulty level numbers associated with the vocal ranges.

Next, the key evaluation information 13d is described. As mentioned above, the key evaluation information 13d corresponds to a musical instrument and contains a key and an evaluation value associated with the key. An evaluation value associated with a key for each musical instrument is hereinafter referred to as “key difficulty level number”. An example of key evaluation information 13d of a certain musical instrument is shown in Tables 3 and 4 below. Table 3 shows an example of major key evaluation information 13d, and Table 4 shows an example of minor key evaluation information 13d.

TABLE 3

| | Number of | Key difficulty | | Number of | Key difficulty |
|---|---|---|---|---|---|
| Key | sharps | level number | Key | flats | level number |
| C | 0 | 1 | C | 0 | 1 |
| G | 1 | 3 | F | 1 | 2 |
| D | 2 | 5 | Bb | 2 | 4 |
| A | 3 | 9 | Eb | 3 | 8 |
| E | 4 | 17 | Ab | 4 | 16 |
| B | 5 | 33 | Db | 5 | 32 |
| F# | 6 | 65 | Gb | 6 | 64 |

TABLE 4

| | Number of | Key difficulty | | Number of | Key difficulty |
|---|---|---|---|---|---|
| Key | sharps | level number | Key | flats | level number |
| A | 0 | 1 | A | 0 | 1 |
| E | 1 | 3 | D | 1 | 2 |
| B | 2 | 5 | G | 2 | 4 |
| F# | 3 | 9 | C | 3 | 8 |
| C# | 4 | 17 | F | 4 | 16 |
| G# | 5 | 33 | Bb | 5 | 32 |
| D# | 6 | 65 | Eb | 6 | 64 |

As shown in Tables 3 and 4, the key difficulty level number, whether in a major key or a minor key, is set to become larger as the number of key signatures (sharps or flats) increases according to key, and a larger key difficulty level number shows that it is more difficult to play the musical instrument. That is, a larger number of key signatures shows that it is more difficult to play the musical instrument. It should be noted that the setting of key difficulty level numbers for each key is arbitrary. The key-dependent difficulty level of playing of a musical instrument varies according to the kind of the musical instrument. Therefore, the key evaluation information 13d is set for each musical instrument. Key evaluation information 13d containing keys and key difficulty level numbers associated with the keys may be stored in the storage unit 13 for each musical instrument as data tables such as those shown in Tables 3 and 4. The “number of sharps” and the “number of flats” in Tables 3 and 4 do not need to be contained in the key evaluation information 13d. It should be noted that the key evaluation information 13d is not necessarily associated with the sound range evaluation information 13c.

With continued reference to FIG. 2, as mentioned above, the data acquisition unit 107 acquires sound range evaluation information 13c and key evaluation information 13d both corresponding to the musical instrument to be used from the storage unit 13 and outputs them to the transposition amount determination unit 109. Furthermore, the data acquisition unit 107 acquires desired music data 13b from the storage unit 13 and outputs it to the transposition amount determination unit 109. As mentioned above, in a case where the transposing device 10 deals with a piece of music related to singing, the key evaluation information 13d may be omitted. In this case, the data acquisition unit 107 acquires sound range evaluation information 13c corresponding to the vocal range of a singer and desired music data 13b from the storage unit 13 and outputs them to the transposition amount determination unit 109.

The data acquisition unit 107 may include a transposition necessity determination unit 111. The transposition necessity determination unit 111 determines the necessity or nonnecessity of transposition of a piece of music on the basis of music data 13b and sound range evaluation information 13c corresponding to the musical instrument to be used or the vocal range. Specifically, the transposition necessity determination unit 111 identifies whether the lowest and highest sounds in the pitch information of the piece of music contained in the music data 13b fall within the standard sound range of the musical instrument to be used or the class of voice of the singer. When at least either of the lowest and highest sounds in the pitch information of the piece of music is out of the standard sound range, the transposition necessity determination unit 111 determines that it is necessary to transpose the piece of music.

Although an example is described here in which the transposition necessity determination unit 111 identifies whether the lowest and highest sounds in the pitch information of a piece of music fall within the standard sound range of the musical instrument to be used or the class of voice of the singer, the sound range of the musical instrument or the class of voice of the singer that is compared with the pitch information of the piece of music is not limited to the standard sound range. For example, in a case where priority is given to the key of the piece of music as original, the transposition necessity determination unit 111 may determine the necessity or nonnecessity of transposition of the piece of music by comparing the pitch information of the piece of music with the playable sound range of the musical instrument to be used or the singable sound range of the singer, including the rated sound range or the special sound range.

In a case where the data acquisition unit 107 includes the transposition necessity determination unit 111, when the transposition necessity determination unit 111 determines that it is not necessary to transpose the piece of music, the data acquisition unit 107 directly outputs the music data 13b thus acquired to the display unit 15. On the other hand, when the transposition necessity determination unit 111 determines that it is necessary to transpose the piece of music, the data acquisition unit 107 outputs the music data 13b, the sound range evaluation information 13c, and the key evaluation information 13d thus acquired to the transposition amount determination unit 109 in the case of transposing the piece of music in accordance with the sound range of the musical instrument.

The transposition amount determination unit 109 acquires the music data 13b, the sound range evaluation information 13c, and the key evaluation information 13d from the data acquisition unit 107. Upon acquiring the music data 13b, the sound range evaluation information 13c, and the key evaluation information 13d, the transposition amount determination unit 109 determines an amount of transposition of the piece of music on the basis of the sound range corresponding to the musical instrument contained in the sound range evaluation information 13c, the pitch information of the piece of music and the key (key information) of the piece of music contained in the music data 13b, and the key evaluation information 13d. Specifically, the transposition amount determination unit 109 calculates evaluation values on the basis of a relationship between the sound range corresponding to the musical instrument contained in the sound range evaluation information 13c and the pitch information of the music data 13b and a relationship between the key (key information) of the piece of music and the key evaluation information 13d. A method for determining an amount of transposition will be described in detail later. The transposition amount determination unit 109 transposes the pitch information, the accompaniment information, and the like contained in the music data 13b on the basis of the amount of transposition thus determined. The transposition amount determination unit 109 outputs the pitch information thus transposed to the display unit 15. The display unit 15 displays a musical score based on the pitch information transposed by and acquired from the transposition amount determination unit 109.

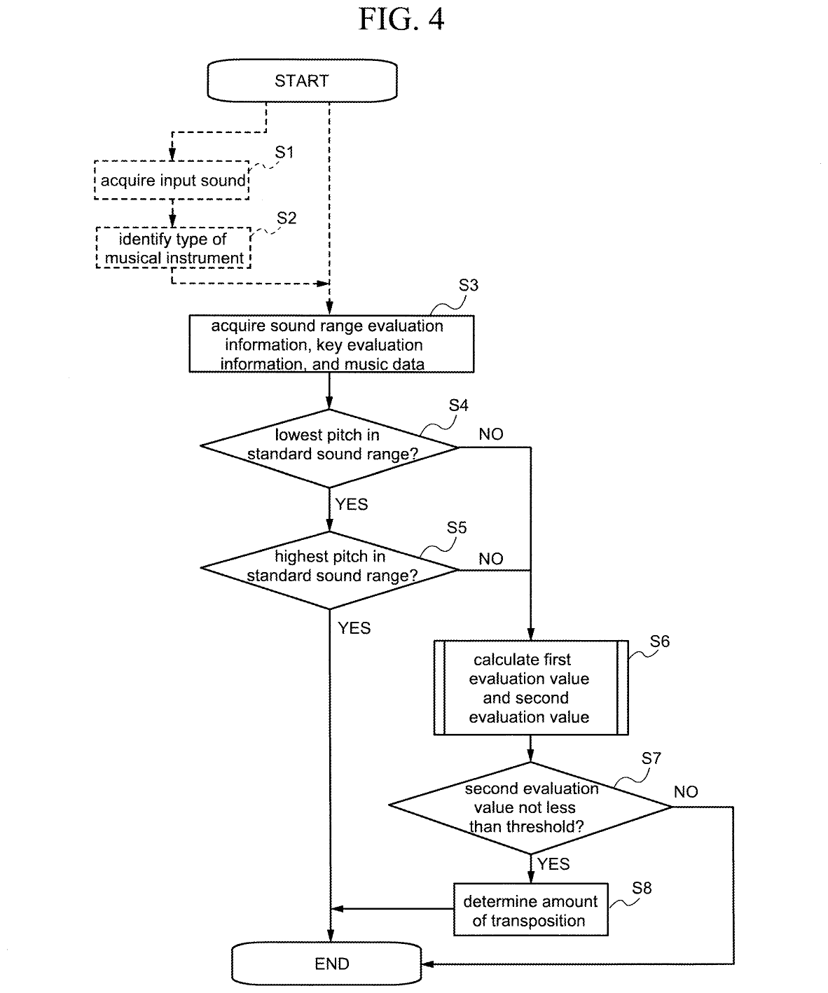

FIG. 4 is a flow chart showing the flow of a method that is executed by the configuration of the transposing function 100 shown in FIG. 2 according to an embodiment of the present invention for transposing a piece of music in the case of transposing the piece of music in accordance with the sound range of a musical instrument. In the following, a method for transposing a piece of music that is executed by the configuration of the transposing function 100 according to an embodiment of the present invention is described in detail with reference to FIGS. 2 and 4. It should be noted that the transposing method to be described below is merely an example, and a transposing method of the present invention is not necessarily limited to the transposing method to be described below.

The following describes a case where the data acquisition unit 107 includes the transposition necessity determination unit 111. As mentioned above, the user of the transposing device 10 can use the operation unit 21 to designate the kind of musical instrument to use. In a case where the user uses the operation unit 21 to designate the kind of a musical instrument, musical instrument information indicating the kind of the musical instrument is input to the data acquisition unit 107. Meanwhile, the transposing function 100 may identify the kind of musical instrument the user uses based on an input sound of a musical instrument. First, in the case of identifying the kind of a musical instrument on the basis of an input sound of the musical instrument, the input sound acquisition unit 103 acquires the input sound (S1). Next, the identification unit 105 identifies the kind of the musical instrument on the basis of the input sound thus acquired (S2). Specifically, the identification unit 105 acquires musical instrument data 13e from the storage unit 13, compares the musical instrument data 13e with the input sound, and identifies what musical instrument corresponds to the input sound. The identification unit 105 outputs information indicating the musical instrument thus identified to the data acquisition unit 107. In a case where the user uses the operation unit 21 to designate the kind of a musical instrument, steps S1 and S2 may be omitted. Further, in a case where the transposing device 10 targets a particular musical instrument, steps S1 and S2 may be omitted, as sound range evaluation information 13c and key evaluation information 13d both corresponding to the particular musical instrument have already been configured.

Once the kind of a musical instrument is identified, the data acquisition unit 107 acquires sound range evaluation information 13c and key evaluation information 13d both corresponding to the musical instrument to be used from the storage unit 13 on the basis of information indicating the musical instrument (S3). Further, the data acquisition unit 107 acquires music data 13b from the storage unit 13. The transposition necessity determination unit 111 identifies, on the basis of the sound range evaluation information 13c, whether the lowest note in the pitch information of the piece of music contained in the music data 13b falls within the standard sound range of the musical instrument to be used (S4). When the lowest note in the piece of music falls within the standard sound range of the musical instrument to be used, the transposition necessity determination unit 111 then identifies, on the basis of the sound range evaluation information 13c, whether the highest note in the pitch information of the piece of music falls within the standard sound range of the musical instrument to be used (S5). Note here that the order of steps S4 and S5 may be reversed. In a case where both the lowest and highest sounds in the pitch information of the piece of music fall within the standard sound range of the musical instrument to be used, the transposition necessity determination unit 111 determines that it is not necessary to transpose the piece of music. On the other hand, in a case where at least either of the lowest and highest sounds in the pitch information of the piece of music is out of the standard sound range, the transposition necessity determination unit 111 determines that it is necessary to transpose the piece of music.

Although an example has been described here in which the transposition necessity determination unit 111 identifies whether the lowest and highest sounds in the pitch information of a piece of music fall within the standard sound range of the musical instrument to be used, the sound range of the musical instrument that is compared with the pitch information of the piece of music is not limited to the standard sound range of the sound range evaluation information 13c. For example, in a case where priority is given to the key of the piece of music as original, the transposition necessity determination unit 111 may determine the necessity or nonnecessity of transposition of the piece of music by comparing the pitch information of the piece of music with the playable sound range of the musical instrument to be used, including the rated sound range or the special sound range.

As mentioned above, in a case where the transposition necessity determination unit 111 has determined that it is not necessary to transpose the piece of music, the data acquisition unit 107 directly outputs the music data 13b thus acquired to the display unit 15. On the other hand, in a case where the transposition necessity determination unit 111 has determined that it is necessary to transpose the piece of music, the data acquisition unit 107 outputs the music data 13b, the sound range evaluation information 13c, and the key evaluation information 13d thus acquired to the transposition amount determination unit 109.

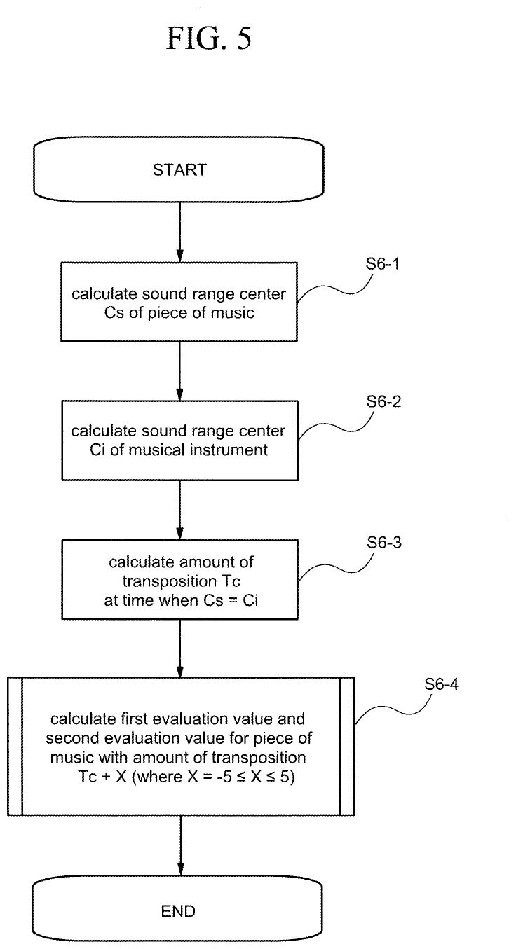

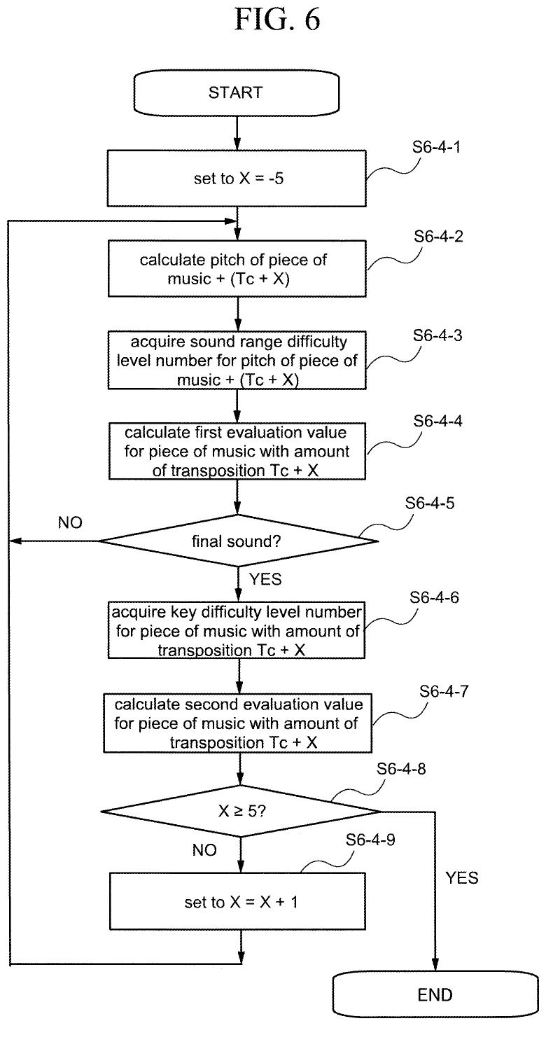

Once the transposition necessity determination unit 111 determines through steps S4 and S5 that it is necessary to transpose the piece of music, the transposition amount determination unit 109 determines an amount of transposition of the piece of music on the basis of the music data 13b, the sound range evaluation information 13c, and the key evaluation information 13d. As shown in FIG. 4, the transposition amount determination unit 109 first calculates a first evaluation value on the basis of the pitch information of the piece of music and the sound range evaluation information 13c and then calculates a second evaluation value (transposition evaluation value) on the basis of the key information of the piece of music and the key evaluation information 13d (S6). In the following, the calculation of the first evaluation value and the calculation of the second evaluation value (S6) in FIG. 4 are described in detail with reference to FIGS. 5 and 6.

FIG. 5 is a flow chart for explaining in more detail a concept of the calculation of the first evaluation value and the calculation of the second evaluation value (S6). As shown in FIG. 5, the transposition amount determination unit 109 calculates a sound range center Cs of the piece of music on the basis of the music data 13b (S6-1). Specifically, the transposition amount determination unit 109 calculates, as the sound range center Cs, the middle pitch between the highest and lowest pitches of the pitch information of the piece of music contained in the music data 13b. In a case where the middle pitch between the highest and lowest pitches of the piece of music has a decimal part, the decimal part may be rounded down or up. Next, the transposition amount determination unit 109 calculates a sound range center Ci of the musical instrument on the basis of the sound range evaluation information 13c (S6-2). Specifically, the transposition amount determination unit 109 calculates, as the sound range center Ci, the middle pitch between the highest and lowest sounds emitted from the musical instrument. In a case where the middle between the highest and lowest pitches of the musical instrument has a decimal part, the decimal part may be rounded down or up. Note here that the order of steps S6-1 and S6-2 may be reversed.

Next, the transposition amount determination unit 109 calculates a difference ΔC between the sound range center Cs of the piece of music and the sound range center Ci of the musical instrument. Note here that ΔC=(Sound range center Cs of piece of music)−(Sound range center Ci of musical instrument). That is, ΔC represents an amount of transposition Tc by which the piece of music is transposed when (Sound range center Cs of piece of music)=(Sound range center Ci of musical instrument). That is, the transposition amount determination unit 109 calculates the amount of transposition Tc at the time when (Sound range center Cs of piece of music)=(Sound range center Ci of musical instrument) (S6-3).

Next, the transposition amount determination unit 109 calculates first evaluation values of the piece of music for calculated amounts of transposition Tc+X (where −5≤X≤5), i.e. amounts of transposition Tc−5 to Tc+5, and, on the basis of the first evaluation values of the piece of music with the amounts of transposition Tc−5 to Tc+5 thus calculated and the key information of the piece of music with the amounts of transposition Tc+X (where −5≤X≤5), calculates second evaluation values of the piece of music for the amounts of transposition Tc+X (where −5≤X≤5), i.e. the amounts of transposition Tc−5 to Tc+5 (S6-4). In the following, step S6-4 shown in FIG. 5 is described in detail with reference to FIG. 6.

First, the transposition amount determination unit 109 sets X of the amount of transposition Tc+X (where −5≤X≤5) to −5 (S6-4-1). Next, the transposition amount determination unit 109 calculates a pitch corresponding to an amount of transposition Tc+X (where −5≤X≤5) on the basis of the pitch information of the piece of music contained in the music data 13b (S6-4-2). Since the transposition amount determination unit 109 has set X to −5 in S6-4-1, the transposition amount determination unit 109 first calculates a pitch corresponding to an amount of transposition Tc+X (where X=−5). Specifically, the transposition amount determination unit 109 calculates a pitch corresponding to the amount of transposition Tc+(−5) by adding the amount of transposition Tc+(−5) to each of note numbers corresponding to sounds contained in the piece of music.

The transposition amount determination unit 109 acquires sound range difficulty level numbers on the basis of the sound range evaluation information 13c for Pitch of Piece of Music+(Tc+X) (where −5≤X≤5) (S6-4-3). Since the transposition amount determination unit 109 has set X to −5 in S6-4-1, the transposition amount determination unit 109 first acquires the sound range difficulty level number of Pitch of Piece of Music+(Tc+X) (where X=−5). Specifically, the transposition amount determination unit 109 obtains a note number (pitch) by adding the amount of transposition Tc+(−5) to a note number corresponding a sound contained in the piece of music, and then the transposition amount determination unit 109 acquires, with reference to the sound range contained in the sound range evaluation information 13c corresponding to the musical instrument to be used, a sound range difficulty level number associated with a sound range in which the note number thus obtained is included.

For more detailed explanation, it is assumed, for example, that the musical instrument to be used is an alto saxophone and sound range evaluation information 13c corresponding to an alto saxophone is the aforementioned Table 2. Further, it is also assumed that the note number of a sound contained in the piece of music is 64. In this case, for example, when Tc=3 and X=−5, the note number corresponding to the pitch obtained in S6-4-2 is 62. As shown in FIG. 3 and Table 1, the sound range of an alto saxophone that corresponds to note number 62 is the standard sound range. Further, according to the sound range evaluation information 13c shown in Table 2, the sound range difficulty level number associated with the standard sound range of an alto saxophone is 0. Accordingly, the sound range difficulty level number obtained in S6-4-3 when the note number is 64, Tc=3, and X=−5 is 0.

Further, for example, when the note number is 56, Tc=3, and X=−5, the note number corresponding to the pitch obtained in S6-4-2 is 54. As shown in FIG. 3 and Table 1, the sound range of an alto saxophone that corresponds to note number 54 is the low-pitched rated sound range. Further, according to the sound range evaluation information 13c shown in Table 2, the sound range difficulty level number associated with the rated sound range of an alto saxophone is 10. Accordingly, the sound range difficulty level number obtained in S6-4-3 when the note number is 56, Tc=3, and X=−5 is 10.

Next, the transposition amount determination unit 109 calculates a first evaluation value for Pitch of Piece of Music+(Tc+X) (where −5≤X≤5) (S6-4-4). The first evaluation value indicates the sound range difficulty level number of the piece of music with an amount of transposition Tc+X in a case where X is in the sound range of −5≤X≤5. Specifically, the first evaluation value is a total of sound range difficulty level numbers with respect to sounds contained in the piece of music with an amount of transposition Tc+X in each of cases where X=−5, X=−4, X=−3, . . . , X=4, and X=5. Since the transposition amount determination unit 109 has set X to −5 in S6-4-1, the transposition amount determination unit 109 calculates the first evaluation value for Pitch of Piece of Music+(Tc+X) (where X=−5).

A method for calculating a first evaluation value, for example, in a case where a piece of music M is composed of five sounds a, b, c, d, and e (where a to e are note numbers), Tc=3, and X=−5 is described. Note here that the first evaluation value is a total of sound range difficulty level numbers of all of the sounds contained in the piece of music M. First, for the sound a, which is the first sound of the piece of music M, the transposition amount determination unit 109 acquires a sound range difficulty level number corresponding to the sound a through steps S6-4-2 and S6-4-3. In S6-4-4, the transposition amount determination unit 109 calculates a first evaluation value Sa of the piece of music M by adding sound range difficulty level numbers up to the sound a. Since the sound a is the first sound of the piece of music M here, the first evaluation value Sa of the piece of music M is the sound range difficulty level number corresponding to the sound a.

Next, the transposition amount determination unit 109 determines whether the sound a is the final sound of the piece of music M (S6-4-5). Since the sound a is the first sound of the piece of music M here, the transposition amount determination unit 109 returns to step S6-4-2 and, for the sound b, which is the second sound of the piece of music M, acquires a sound range difficulty level number corresponding to the sound b through steps S6-4-2 and S6-4-3. In S6-4-4, the transposition amount determination unit 109 calculates a first evaluation value Sb of the piece of music M by adding the sound range difficulty level number corresponding to the sound b to the sound range difficulty level number of the sound a, i.e. the first evaluation value Sa of the piece of music M. Since the sound b is the second sound of the piece of music M here, the first evaluation value Sb of the piece of music M is Sa+(Sound range difficulty level number corresponding to sound b).

Next, the transposition amount determination unit 109 determines whether the sound b is the final sound of the piece of music M (S6-4-5). Since the sound b is the second sound of the piece of music M here, the transposition amount determination unit 109 returns to step S6-4-2 and, for the sound c, which is the third sound of the piece of music M, acquires a sound range difficulty level number corresponding to the sound c through steps S6-4-2 and S6-4-3. In S6-4-4, the transposition amount determination unit 109 calculates a first evaluation value Sc of the piece of music M by adding the sound range difficulty level number corresponding to the sound c to a total of the sound range difficulty level numbers of the sound a and b, i.e. the first evaluation value Sb of the piece of music M. Since the sound c is the third sound of the piece of music M here, the first evaluation value Sc of the piece of music M is Sb+(Sound range difficulty level number corresponding to sound c).

Next, the transposition amount determination unit 109 determines whether the sound c is the final sound of the piece of music M (S6-4-5). Since the sound c is the third sound of the piece of music M here, the transposition amount determination unit 109 returns to step S6-4-2 and, for the sound d, which is the fourth sound of the piece of music M, acquires a sound range difficulty level number corresponding to the sound d through steps S6-4-2 and S6-4-3, as is the case with the sounds a to c. In S6-4-4, the transposition amount determination unit 109 calculates a first evaluation value Sd of the piece of music M by adding the sound range difficulty level number corresponding to the sound d to a total of the sound range difficulty level numbers of the sounds a to c, i.e. the first evaluation value Sc of the piece of music M. The first evaluation value Sd of the piece of music M up to the sound d is Sc+(Sound range difficulty level number corresponding to sound d).

Next, the transposition amount determination unit 109 determines whether the sound d is the final sound of the piece of music M (S6-4-5). Since the sound d is the fourth sound of the piece of music M here, the transposition amount determination unit 109 returns to step S6-4-2 and acquires a sound range difficulty level number corresponding to the sound e, which is the final sound of the piece of music M, through steps S6-4-2 and S6-4-3, as is the case with the sounds a to d. In S6-4-4, the transposition amount determination unit 109 calculates a first evaluation value Se of the piece of music M by adding the sound range difficulty level number of the sound e to a total of the sound range difficulty level numbers of the sounds a to d, i.e. the first evaluation value Sd of the piece of music M. The first evaluation value Se of the piece of music M up to the sound e is Sd+(Sound range difficulty level number corresponding to sound e). Since the sound e is the final sound of the piece of music M here, the first evaluation value Se of the piece of music M up to the sound e is a first evaluation value of the piece of music M as a whole in a case where X=−5. The transposition amount determination unit 109 determines whether the sound e is the final sound of the piece of music M (S6-4-5). Since the sound e is the final sound of the piece of music M here, the transposition amount determination unit 109 determines that the sound e is the final sound of the piece of music M, and proceeds to the next step S6-4-6.

In the foregoing, for example, the transposition amount determination unit 109 calculates the first evaluation value of the piece of music M as a whole in a case where Tc=3 and X=−5 by acquiring sound range difficulty level numbers for all of the sounds (a to e) that constitute the piece of music M, respectively, and adding together the sound range difficulty level numbers thus acquired. Alternatively, the transposition amount determination unit 109 may calculate a first evaluation value of a piece of music as a while by acquiring sound range difficulty level numbers for some of the sounds that constitute the piece of music and adding together the sound range difficulty level numbers thus acquired. For example, the transposition amount determination unit 109 may acquire, for the highest and lowest ones of the sounds that constitute a piece of music, sound range difficulty level numbers with an amount of transposition of Tc+X (where −5≤X≤5), add together the sound range difficulty level numbers thus acquired of the highest and lowest sounds, and yield a result of the addition as a first evaluation value of the piece of music as a whole.

On the basis of the key information of the piece of music with an amount of transposition of Tc+X (where −5≤X≤5) and the key evaluation information 13d corresponding to the musical instrument to be used, the transposition amount determination unit 109 acquires key difficulty level numbers corresponding to the keys of the piece of music with an amount of transposition of Tc+X (where −5≤X≤5) (S6-4-6). Since it has set X to −5 in S6-4-1, the transposition amount determination unit 109 first acquires a key difficulty level number corresponding to the key of the piece of music with an amount of transposition of Tc+X (where X=−5). Specifically, the transposition amount determination unit 109 acquires the key information of the piece of music to be transposed. In a case where the music data 13b contains the key information of the piece of music, the transposition amount determination unit 109 acquires the key information of the piece of music on the basis of the music data 13b. In a case where the music data 13b does not contain the key information of the piece of music, the transposition amount determination unit 109 may obtain key information by identifying the key of the piece of music on the basis of the pitch information contained in the music data 13b and the number, proportion, and the like of key signatures (sharps and/or flats) in the piece of music.

Upon acquiring the key information of the piece of music to be transposed, the transposition amount determination unit 109 identify the key of the piece of music when notes of the piece of music are transposed by Tc+X (where X=−5). On the basis of the key thus identified of the piece of music thus transposed and the key evaluation information 13d corresponding to the musical instrument to be used, the transposition amount determination unit 109 acquires a key difficulty level with respect to the piece of music thus transposed.

For example, in a case where Tc=3 and X=−5, the amount of transposition is −2. In a case where the piece of music M is in C major, transposing the notes of the piece of music M by −2 causes the piece of music thus transposed to be in Bb major. Table 5 below shows amounts of transposition and transposed keys associated with the amounts of transposition in a case where a piece of music is in C major. In the column “number of sharps” of Table 5, the negative (−) numerical values represent the numbers of flats (b). In the case of another major or minor key, too, transposed keys can be identified on the basis of the key of a piece of music and amounts of transposition.

TABLE 5

| Amount of transposition | Key | Number of Sharps |
|---|---|---|
| 0 | C | 0 |
| 1 | Db | −5 |
| 2 | D | 2 |
| 3 | Eb | −3 |
| 4 | E | 4 |
| 5 | F | −1 |
| 6 (−6) | F# | 6 |
| −5 | G | 1 |
| −4 | Ab | −4 |
| −3 | A | 3 |
| −2 | Bb | −2 |
| −1 | B | 5 |
| 0 | C | 0 |

Assuming here that the key evaluation information 13d of the musical instrument to be used is the key evaluation information shown in Table 3 above, the key difficulty level number in Bb major of the musical instrument to be used is 4. In this way, the transposition amount determination unit 109 can acquire a key difficulty level number corresponding to the key of the piece of music with an amount of transposition of Tc+X (where X=−5).

Next, the transposition amount determination unit 109 calculates a second evaluation value for the piece of music with an amount of transposition of Tc+X (where −5≤X≤5) (S6-4-7). The term “second evaluation value” here refers to the difficulty level number of the piece of music with an amount of transposition of Tc+X (where −5≤X≤5). Since the transposition amount determination unit 109 is set X to −5 in S6-4-1, the transposition amount determination unit 109 first calculates a second evaluation value for the piece of music with an amount of transposition of Tc+X (where X=−5). The second evaluation value is calculated on the basis of the first evaluation value indicating the sound range difficulty level number of the piece of music as a whole in a case where X is −5 and the key difficulty level number, acquired in S6-4-6, that corresponds to the key of the piece of music with an amount of transposition of Tc+X (where X=−5).

For example, the second evaluation value of such a piece of music M in C major which is composed of five sounds a, b, c, d, and e (where a to e are note numbers) when Tc=3 and X=−5 as described above can be calculated using the following equation: Second evaluation value of piece of music M=First evaluation value Se+4. Note here that the “first evaluation value Se” is the sound range difficulty level number of the piece of music M as a whole with X=−5 as calculated through steps S6-4-2 to S6-4-4 and “4” is the key difficulty level number of the piece of music M transposed from C major to B major with Tc=3 and X=−5 as acquired in S6-4-6.

Through steps S6-4-1 to S6-4-7 described above, the second evaluation value of the piece of music with an amount of transposition of Tc+X (where X=−5) is calculated. Next, the transposition amount determination unit 109 determines whether it has calculated all second evaluation values for the piece of music with the amounts of transposition of Tc+X (where −5≤X≤5) (S6-4-8). That is, the transposition amount determination unit 109 determines whether it has calculated a second evaluation value of the piece of music with an amount of transposition of Tc+X for each of the cases where X=−5, X=−4, X=−3, . . . , X=4, and X=5. In the case of having calculated all second evaluation values for the piece of music with amounts of transposition of Tc+X in the cases where X=−5, X=−4, X=−3, . . . , X=4, and X=5, respectively, the transposition amount determination unit 109 proceeds to S7 shown in FIG. 4.

In the case of having not calculated all second evaluation values for the piece of music with the amounts of transposition Tc+X in the cases where X=−5, X=−4, X=−3, . . . , X=4, and X=5, respectively, the transposition amount determination unit 109 sets X of the amount of transposition Tc+X to X+1 (S6-4-9) and returns to step S6-4-2. Specifically, after having calculated a second evaluation value for the piece of music with an amount of transposition of Tc+X (where X=−5), the transposition amount determination unit 109 sets to X=(−5)+1, i.e. X=−4 and executes S6-4-2 to S6-4-7 to calculate first and second evaluation values for the piece of music with an amount of transposition of Tc+X (where X=−4). The transposition amount determination unit 109 repeats the aforementioned steps S6-4-2 to S6-4-9 until it finishes calculating all second evaluation value for the piece of music with amounts of transposition of Tc+X in the cases where X=−5, X=−4, X=−3, . . . , X=4, and X=5, respectively.

Having calculated all second evaluation values for the piece of music with amounts of transposition of Tc+X (where −5≤X≤5), the transposition amount determination unit 109 determines whether all of the second evaluation values thus calculated are less than a predetermined threshold (S7). That is, the transposition amount determination unit 109 determines whether the difficulty level of the piece of music with an amount of transposition Tc+X in each of the cases where X=−5, X=−4, X=−3, . . . , X=4, and X=5 is less than the predetermined threshold. Further, in a case where a second evaluation value is less than the predetermined threshold, the transposition amount determination unit 109 may classify the second evaluation value on the basis of the magnitude of the second evaluation value. Table 6 below shows an example of the classifications of second evaluation values according to the magnitude of the second evaluation values. In Table 6, the second evaluation values are denoted by S_{Tc+x}.

TABLE 6

| Sound range | Second evaluation value |
|---|---|
| Normal | S_{Tc+X} < 10 |
| Attentional | 10 < S_{Tc+X} < 100 |
| Cautionary | 100 < S_{Tc+X} < 1000 |
| Non-transposable | S_{Tc+X} ≥ 1000 |

As shown in Table 6, when a second evaluation value S_{Tc+X} is not less than the predetermined threshold, the transposition amount determination unit 109 determines that it is impossible to transpose the piece of music with an amount of transposition Tc+X corresponding to the second evaluation value S_{Tc+X} that is not less than the predetermined threshold. As an example, Table 6 shows that it is impossible to execute transposition with a second evaluation value S_{Tc+X} being not less than 1000. This indicates that the piece of music to be transposed with an amount of transposition Tc+X corresponding to a second evaluation value S_{Tc+X} that is not less than the predetermined threshold includes a sound range of musical notes that cannot be played on the musical instrument to be used. It should be noted that although the threshold takes on 1000 as an example here, the threshold is not limited to this value but may take on any value. In a case where all of the second evaluation values of the piece of music with amounts of transposition of Tc+X (where −5≤X≤5) are not less than the predetermined threshold, the transposition amount determination unit 109 outputs information indicating that it is impossible to transpose the piece of music to the display unit 15.

Further, as mentioned above, when a second evaluation value S_{Tc+X} is less than 1000, the transposition amount determination unit 109 may classify the second evaluation value S_{Tc+X} according to the magnitude of the second evaluation value. Table 6 shows that in a case where the second evaluation value S_{Tc+X} is less than 10, a second evaluation value of the piece of music with an amount of transposition Tc+X (where −5≤X≤5) falls within a normal sound range, that in a case where the second evaluation value S_{Tc+X} is less than 100, a second evaluation value of the piece of music with an amount of transposition Tc+X (where −5≤X≤5) falls within an attentional sound range, and that in a case where the second evaluation value S_{Tc+X} is less than 1000, a second evaluation value of the piece of music with an amount of transposition Tc+X (where −5≤X≤5) falls within a cautionary sound range. The normal sound range here indicates that the piece of music to be transposed with an amount of transposition Tc+X (where −5≤X≤5) can be easily played on the musical instrument to be used. The attentional sound range indicates that the piece of music to be transposed with an amount of transposition Tc+X (where −5≤X≤5) includes a sound range of musical notes that requires trained skills in playing the musical instrument to be used. Further, the cautionary sound range indicates that the piece of music to be transposed with an amount of transposition Tc+X (where −5≤X≤5) includes a sound range of musical notes that requires proficient skills in playing the musical instrument to be used.

The transposition amount determination unit 109 eliminates amounts of transposition Tc+X (where −5≤X≤5) corresponding to second evaluation values S_{Tc+X} that are not less than the predetermined threshold from candidates for the final amount of transposition of the piece of music, and determines the final amount of transposition from amounts of transposition Tc+X (where −5≤X≤5) corresponding to second evaluation values S_{Tc+X} that are less than the predetermined threshold (S8).

In S8, the transposition amount determination unit 109 identifies an amount of transposition Tc+X (where −5≤X≤5) corresponding to the smallest second evaluation value from the amounts of transposition Tc+X (where −5≤X≤5) corresponding to the second evaluation values S_{Tc+X} that are less than the predetermined threshold, and determines the amount of transposition Tc+X (where −5≤X≤5) thus identified as the final amount of transposition of the piece of music. That is, the transposition amount determination unit 109 determines an amount of transposition that is lowest in difficulty level of playing of the piece of music thus transposed as the final amount of transposition of the piece of music.

The foregoing has described an example of a method that is executed by the configuration of the transposing function 100 according to an embodiment of the present invention for transposing a piece of music in the case of transposing the piece of music in accordance with the sound range of a musical instrument. It should be noted that a method for transposing a piece of music according to an embodiment of the present invention is not limited to the transposing method described with reference to FIGS. 4 to 6 and it is possible, for example, to add, omit, or change steps. For example, although the transposing method described with reference to FIGS. 4 to 6 includes the steps of setting to X=−5 for an amount of transposition Tc+X (where −5≤X≤5) first to calculate a second evaluation value of a piece of music with an amount of transposition Tc+(−5) and then calculating a second evaluation value of the piece of music with an amount of transposition Tc+(−4), the order of setting of X is not particularly limited. Further, in the case of transposing a piece of music in accordance with the vocal range of a singer, the transposition amount determination unit 109 determines whether a first evaluation value of the piece of music M as a whole is less than a predetermined threshold. When the first evaluation value is less than the predetermined threshold, the transposition amount determination unit 109 identifies an amount of transposition Tc+X (where −5≤X≤5) corresponding to the smallest first value of evaluation from amounts of transposition Tc+X (where −5≤X≤5) corresponding to first evaluation values that are less than the predetermined threshold, and determines the amount of transposition Tc+X (where −5≤X≤5) thus identified as the final amount of transposition of the piece of music.

On the basis of the final amount of transposition determined by the method as described above, the transposition amount determination unit 109 transposes the pitch information, the accompaniment information, and the like contained in the music data 13b. The transposition amount determination unit 109 outputs the pitch information thus transposed to the display unit 15. The display unit 15 displays a musical score based on the pitch information transposed by and acquired from the transposition amount determination unit 109. Further, as mentioned above, in a case where a second evaluation value S_{Tc+X} is classified according to the magnitude of the second evaluation value S_{Tc+X}, the transposition amount determination unit 109 may output, to the display unit 15, not only the pitch information thus transposed but also information regarding a sound range corresponding to the final amount of transposition. In this case, on the basis of the information regarding the sound range corresponding to the final amount of transposition, the display unit 15 may display an attentional display indicating that the piece of music thus transposed includes a sound range of musical notes that requires trained skills in playing or a cautionary display indicating that the piece of music thus transposed includes a sound range of musical notes that requires proficient skills in playing in addition to the musical score based on the pitch information thus transposed. Further, the transposition amount determination unit 109 may output a level of playing of the sound range corresponding to the final amount of transposition to the display unit 15. The level of playing may be determined on the basis of the sound range corresponding to the final amount of transposition, the playable sound range (rated sound range, standard sound range, and special sound range) and non-playable sound range (unreachable sound range) of the musical instrument. In this case, the display unit 15 displays the level of playing. In response to the level of playing displayed on the display unit 15, the player may determine whether to transpose the pitch information and accompaniment information contained in the music data 13b on the basis of the final amount of transposition and give an instruction via a user interface, such as a touch panel, that is provided by the transposing device 10. The user interface may be provided to the display unit 15 or may be separately provided. When the transposition amount determination unit 109 has determined that that all of the second evaluation values of the piece of music with the amounts of transposition of Tc+X (where −5≤X≤5) are not less than the predetermined threshold, the display unit 15 may perform an error display on the basis of information, output from the transposition amount determination unit 109, that indicates that it is impossible to transpose the piece of music.

It should be noted the transposing method described above is merely an example for explaining an embodiment of the present invention. Accordingly, the present invention is not necessarily limited to the transposing method described above, provided an amount of transposition is determined on the basis of evaluation values calculated based on a sound range contained in sound range evaluation information 13c corresponding to a musical instrument, pitch information contained in music data 13b, key information of a piece of music, and key evaluation information 13d.

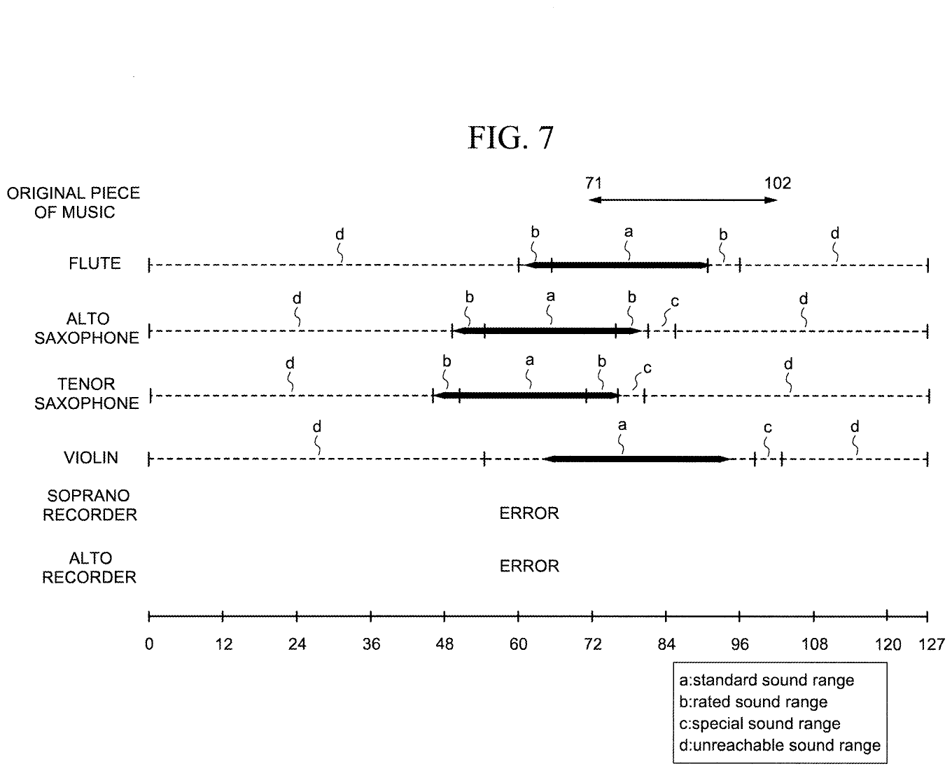

FIG. 7 is a diagram explaining an example of transposition of the flute, the alto saxophone, the tenor saxophone, the violin, the soprano recorder, and the alto recorder shown in FIG. 4. FIG. 7 shows, as an example, a case where the sound range of an original piece of music ranges from note number 71 to note number 102. The sound ranges after transposition of the original piece when playing on each of musical instruments are indicated by heavy lines in FIG. 7. As for the flute, the alto saxophone, and the tenor saxophone, the sound range of the original piece of music is transposed toward lower pitch so that their post-transposition sound ranges do not overlap their unreachable sound ranges.

Further, the playable sound range of the violin sound ranges from note number 55 to note number 102, and as shown in FIG. 7, the sound range of the original piece of music is transposed toward lower pitch so that its post-transposition sound range does not overlap its special sound range. In a case where priority is given to the key of the original piece of music, the transposition necessity determination unit 111 may determine that it is not necessary to transpose the original piece of music, which sound ranges from note number 71 to note number 102. In this case, the pitch information of the original piece of music is not transposed, and the music data 13b of the original piece of music is directly output to the display unit 15.

The soprano recorder and the alto recorder cannot be played, as their post-transposition sound ranges overlap their unreachable sound ranges even when the original piece of music is transposed. This makes it impossible to transpose the original piece of music, resulting in an error.

### (Modification)

The foregoing has stated that the transposing device 10 according to an embodiment of the present invention described in First embodiment calculates a second evaluation value using a total of sound range difficulty level numbers and key difficulty level number of a post-transposed piece of music and determines an amount of transposition that is smallest in magnitude of the second evaluation value as the final amount of transposition. However, in determining the final amount of transposition, a transposing device according to an embodiment of the present invention may determine a range of amounts of transposition on the basis of the sound range information of the musical instrument to be used and the pitch information of the piece of music and determine the final amount of transposition so that the final amount of transposition is included in the range of amounts of transposition. For example, the transposition amount determination unit 109 may determine the final amount of transposition so that the highest and lowest sounds of the piece of music after transposition are included in the standard sound range of the musical instrument to be used. In this case, determining the final amount of transposition so that the highest and lowest sounds of the piece of music after transposition are included in the range of amounts of transposition thus determined may be given priority by the transposition amount determination unit 109 over considering the difficulty level numbers of keys.

Further, according to the transposing device 10 of an embodiment of the present invention described on First embodiment, when the necessity or nonnecessity of transposition of a piece of music is determined, the necessity or nonnecessity of transposition of the piece of music is determined by the transposition necessity determination unit 111 on the basis of the sound range of the musical instrument to be used and the pitch of the piece of music. However, as shown in Tables 3 and 4, key difficulty level numbers vary according to keys of pieces of music, therefore, a piece of music with more key signatures may be more difficult to play depending on the kind of the musical instrument to be used. To address this problem, a transposing device according to an embodiment of the present invention may determine the necessity or nonnecessity of transposition of a piece of music on the basis of the key information of the piece of music in addition to a comparison between the sound range of the musical instrument to be used and the pitch of the piece of music.

For example, when a result of a comparison between the sound range of the musical instrument to be used and the pitch of the piece of music shows that the highest and lowest sounds of the piece of music fall within the standard sound range of the musical instrument to be used, in determining the necessity or nonnecessity of transposition of a piece of music, the transposition necessity determination unit 111 of the transposing device 10 further determines the necessity or nonnecessity of transposition of the piece of music on the basis of the key information of the piece of music and key evaluation information corresponding to the musical instrument to be used. Note here that the key information of the piece of music may be contained in the music data 13b or may be identified on the basis of the pitch information contained in the music data 13b and the number, proportion, and the like of key signatures (sharps and/or flats) in the piece of music. The transposition necessity determination unit 111 refers to the key of the key evaluation information 13d on the basis of the key information to the piece of music to acquire a key difficulty level number associated with a key corresponding to the key of the piece of music. In a case where the key difficulty level number thus obtained is not less than a predetermined threshold, the transposition necessity determination unit 111 determines that it is necessary to transpose the piece of music, even if the highest and lowest sounds of the piece of music fall within the standard sound range of the musical instrument to be used. This makes it possible to determine the necessity or nonnecessity of transposition of a piece of music on the basis of not only a difficulty level number of playing of a musical instrument due to the difference between the sound range of the piece of music and the sound range of the musical instrument but also a key-dependent difficulty level number of playing of the musical instrument to be used.

Although, as an example, a case where a piece of music to be performed on a musical instrument is a target of transposition in First embodiment, the transposing device 10 according to an embodiment of the present invention may target a song. In a case where a song is a target of transposition, the necessity or nonnecessity of transposition of the song may be determined by comparing the pitch information of the song with the low and high register in the vocal range of a singer. In this case, the transposing device 10 obtains the voice of the singer in advance through the sound input unit 19 and the signal processing unit 17 and identifies the vocal range of the singer. Alternatively, the necessity or nonnecessity of transposition of the song may be determined by storing standard vocal ranges of male voices (such as bass and tenor) and standard vocal ranges of female voices (such as alto and soprano) as information contained in the sound range evaluation information 13c in the storage unit 13 of the transposing device 10 and comparing a desired vocal range designated by the user of the transposing device 10 with the pitch information of the song. It should be noted that in a case where a song is a target of transposition, it is preferable that those of the key difficulty level numbers which correspond to the respective key signatures in the key evaluation information 13d be set substantially identical. In a case where a song is a target of transposition, an amount of transposition is determined in the same manner as in the aforementioned case where a piece of music is a target of transposition.

As described above, a transposing device, a transposing method, and a program of the present invention make it possible to, in transposing a piece of music in accordance with the sound range of a musical instrument or the vocal range of a singer, determine an amount of transposition in consideration of a key signature resulting from the transposition. They also make it possible to determine an amount of transposition in consideration of the key-dependent difficulty level of playing of a musical instrument according to the kind of the musical instrument.

A configuration obtained by a person skilled in the art making an addition, deletion, or design variation of a constituent element as appropriate or making an addition, omission, or condition alternation of a step on the basis of a configuration described as an embodiment of the present invention is encompassed in the scope of the present invention, provided such a configuration includes the subject-matter of the present invention.

For example, while the aforementioned embodiment is configured to obtain a transposition evaluation value through the use of sound range evaluation information 13c containing a sound range corresponding to a musical instrument and an evaluation value associated with the sound range, key evaluation information 13d corresponding to the musical instrument and indicating a relationship between a key and an evaluation value associated with the key, and music data 13b containing pitch information, this is merely an example. The aforementioned aspect does not imply any limitation, provided a transposition evaluation value can be obtained through the use of at least either a sound range or a key and music data and an amount of transposition can be determined through the use of the transposition evaluation value.

Furthermore, although it has been described that the evaluation value is calculated by using three pieces of information, namely sound range evaluation information, key evaluation information, and pitch information, none of all these pieces of information may be essential. For example, an evaluation value may be calculated using only a relationship between a predetermined sound range and the key of a piece of music, may be calculated using a relationship between a predetermined sound range and the pitch information of a piece of music, or may be calculated using a relationship between music data and a key.

Further, when some pitch is out of a sound range as a result of transposition based on the premise of playing on a wide sound range musical instrument such as a piano and the sound may be permitted as not being played, sound range evaluation information may be omitted from the parameters that are taken into account in the calculation of an evaluation value. Further, while sound range evaluation information is supposed to be associated with a musical instrument, it does not necessarily need to be associated with a musical instrument. For example, the user may select a sound range which is close to that of the musical instrument to be used, or the user may designate a sound range.

Further, pitch information that is used in calculating a first evaluation value may be not the whole of the pitch of a piece of music but a predetermined part of the pitch. For example, music data may be separated phrase by phrase, and predetermined pitch for each phrase may be used for the calculation of a first evaluation value.

Further, although the aforementioned embodiment calculates a second evaluation value through the use of key evaluation information 13d indicating a relationship between a key and an evaluation value associated with the key, key-associated evaluation information that is used for the calculation of a second evaluation value is not limited to the key evaluation information 13d. For example, information indicating a key and a degree of priority of the key for each musical instrument may be used for the calculation of a second evaluation value.

Further, other working effects different from those which are brought about by aspects of the aforementioned embodiments are construed as being naturally brought about by the present invention, provided such working effects are obvious from the descriptions in the specification or easily predictable by persons skilled in the art.

What is claimed is:

1. A transposing device comprising:
a data acquisition unit configured to acquire a predetermined sound range, key information of a predetermined piece of music, and pitch information of sounds constituting the predetermined piece of music; and
a transposition amount determination unit configured to calculate a transposition evaluation value on the basis of the sound range, the key information of the piece of music, and the pitch information and to determine an amount of transposition on the basis of the transposition evaluation value.

2. The transposing device according to claim 1, wherein the date acquisition unit further acquires sound range evaluation information containing an evaluation value associated with the sound range and key evaluation information indicating a relationship between a key and an evaluation value associated with the key, and
the transposition amount determination unit calculates the transposition evaluation value on the basis of the sound range evaluation information and the key evaluation information.

3. The transposing device according to claim 1, further comprising a transposition necessity determination unit configured to determine the necessity or nonnecessity of transposition of the piece of music on the basis of the sound range and the pitch information,
wherein in a case of transposing the piece of music as a result of a determination made by the transposition amount determination unit, the transposition amount determination unit calculates the transposition evaluation value and determines the amount of transposition on the basis of the transposition evaluation value.

4. The transposing device according to claim 3, wherein the transposition amount determination unit determines the necessity or nonnecessity of the transposition on the basis of the key information.

5. The transposing device according to claim 1, further comprising a display unit configured to display a piece of music transposed on the basis of the amount of transposition thus determined.

6. The transposing device according to claim 1, wherein the transposition amount determination unit determines a range of amounts of transposition on the basis of the sound range and the pitch information and determines the amount of transposition so that the amount of transposition is included in the range of amounts of transposition.

7. The transposing device according to claim 2, further comprising:
an input acquisition unit configured to acquire an input sound; and
an identification unit configured to identify the sound range evaluation information on the basis of the input sound.

8. The transposing device according to claim 1, wherein the sound range includes a sound range of a music instrument or a vocal range.

9. A transposing method comprising:
acquiring a predetermined sound range, key information of a predetermined piece of music, and pitch information of sounds constituting the predetermined piece of music;
calculating a transposition evaluation value on the basis of the sound range, the key information of the piece of music, and the pitch information; and
determining an amount of transposition on the basis of the transposition evaluation value.

10. The transposing method according to claim 9, further comprising acquiring sound range evaluation information containing an evaluation value associated with the sound range and key evaluation information indicating a relationship between a key and an evaluation value associated with the key,
wherein the transposition evaluation value is calculated on the basis of the sound range evaluation information and the key evaluation information.

11. The transposing method according to claim 9, further comprising determining the necessity or nonnecessity of transposition of the piece of music on the basis of the sound range and the pitch information,
wherein in a case of transposing the piece of music as a result of a determination, the amount of transposition is determined on the basis of the transposition evaluation value.

12. The transposing method according to claim 11, wherein determining the necessity or nonnecessity of the transposition includes determining the necessity or nonnecessity of the transposition on the basis of the key information.

13. The transposing method according to claim 9, further comprising displaying a piece of music transposed on the basis of the amount of transposition thus determined.

14. The transposing method according to claim 9, wherein determining the amount of transposition includes determining a range of amounts of transposition on the basis of the sound range and the pitch information and determining the amount of transposition so that the amount of transposition is included in the range of amounts of transposition.

15. The transposing method according to claim 10, further comprising:
acquiring an input sound; and
identifying the sound range evaluation information on the basis of the input sound.

16. The transposing method according to claim 9, wherein the sound range includes a sound range of a music instrument or a vocal range.

17. A non-transitory computer-readable storage medium recording a program for causing a computer to execute operations comprising:
acquiring a predetermined sound range, key information of a predetermined piece of music, and pitch information of sounds constituting the predetermined piece of music;
calculating a transposition evaluation value on the basis of the sound range, the key information of the piece of music, and the pitch information; and
determining an amount of transposition on the basis of the transposition evaluation value.

18. The non-transitory computer-readable storage medium according to claim 17, wherein the sound range includes a sound range of a music instrument or a vocal range.
